(19) United States
(12) Patent Application Publication
(10) Pub. No.: US 2014/0173441 A1
(43) Pub. Date: Jun. 19, 2014

(54) Method and system for inserting immersive contents into eBook

(71) Applicant: HCL Technologies Limited, Chennai (IN)

(72) Inventors: Ramprasath Venugopal, Chennai (IN); Arun Prasad Subbarayan, Chennai (IN)

(21) Appl. No.: 13/922,226

(22) Filed: Jun. 19, 2013

(30) Foreign Application Priority Data
Dec. 19, 2012 (IN) 5315/CHE/2012

(51) Int. Cl. G06F 3/0484

(52) U.S. Cl. CPC G06F 3/0484
USPC 715/731

(57) ABSTRACT

A method and system for adding immersive contents into existing eBooks and making interactive and engaging to readers is disclosed. The method and system comprises an authoring tool for adding immersive contents. The immersive contents are added in the form of widgets. The contents for the widgets are inputted by using the authoring tool. The interactive eBook is provided to the user through an application on a device. The application that provides the immersive content to the user comprises a viewer runtime that executes the widgets within the eBook.

### PRIORITY DETAILS

The present application claims priority from Indian Application Number 5315/CHE/2012, filed on 19 Dec. 2012, the disclosure of which is hereby incorporated by reference herein.

### TECHNICAL FIELD

The embodiments herein relate to creation of an electronic book (eBook) and more particularly to a method and system for inserting widgets in eBooks.

### BACKGROUND

Much like an ordinary printed book, electronic books (“eBooks”), or more generally, electronic documents that can be used to present text and pictures to readers. Instead of ink and paper, an electronic book is a collection of digital data with software, known as an electronic book reader application which interprets and present on a display. A variety of devices run electronic book reader application such as desktop and notebook computers, eBook readers, smart phones and/or other mobile devices. One available format for eBooks is defined by the “ePub” standard, which is maintained by the International Digital Publishing Forum (IDPF).

Many people are transitioning from reading physical books to reading eBooks, which have many advantages over physical books, such as more portability, the ability to access the eBook from multiple electronic devices, and text search capability. In addition, eBooks are also easier to purchase and are perceived as environmentally-friendly.

Existing electronic “books” (“e-books”) are essentially printed books transferred into electronic form. Existing e-book authoring tools typically provide word processing-type functions and simple insert or import functions to include objects such as pictures in the flow of the text. As a result, present e-books retain the characteristics of a printed book. Further, the existing e-book is more or less a “direct” conversion of media presented in a printed form to media presented in an electronic form, with some inherent functionality such as search functions. Further, the existing systems do not provide any interactive eBooks, with which user can interact and can extract more information apart from the content being displayed to the user.

In light of above discussion, it is desirable to have a method that provides the user with rich multimedia experience, while reading an eBook. It is further desirable to have a method, which can add immersive contents into existing eBook for providing interactive and engaging experience through an application.

### SUMMARY OF THE EMBODIMENT

Accordingly the embodiment provides a method for providing an interactive eBook to a user, wherein the method comprises adding immersive contents into the eBook in the form of interactive widgets by an authoring tool, converting the eBook with the immersive contents into a format and rendering the converted eBook in the format with the immersive contents to the user.

Accordingly the embodiment provides a system for providing an interactive eBook to a user, wherein the system comprises an authoring tool, an application, wherein the application further comprises a viewer, a viewer runtime along with an integrated circuit further comprising at least one processor, at least one memory having a computer program code within the circuit, the at least one memory and the computer program code with the at least one processor cause the system to add immersive contents into the eBook in the form of interactive widgets by the authoring tool, convert the eBook with the immersive contents into a format and render the converted eBook in the format with the immersive contents to the user.

Accordingly the embodiment provides a computer program product for providing an interactive eBook to a user, wherein the product comprises an authoring tool, a viewer and a viewer runtime, along with an integrated circuit further comprising at least one processor, at least one memory having a computer program code within the circuit, the at least one memory and the computer program code with the at least one processor cause the product to add immersive contents into the eBook in the form of interactive widgets by an authoring tool, convert the eBook with the immersive contents into a format and render the converted eBook in the format with the immersive contents to the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 illustrates a block diagram of smart books platform, according to the embodiments disclosed herein;

FIG. 2 illustrates an architecture of smart books with authoring tool, according to the embodiments disclosed herein;

FIG. 3 illustrates architecture of smart books application, according to embodiments disclosed herein; and

FIG. 4 illustrates an example widget, according to embodiments disclosed herein; and

FIG. 5 illustrates a computing environment implementing the smart books platform, as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for adding immersive contents into existing eBooks and making it interactive and engaging to readers. The method and system disclosed herein provides a smart books platform that includes an authoring tool, which is used to add immersive contents to an existing eBook. Once the immersive content is added to an existing eBook, it is converted into a custom file format. The immersive content of the eBook is rendered to a user through an application implemented in a device.

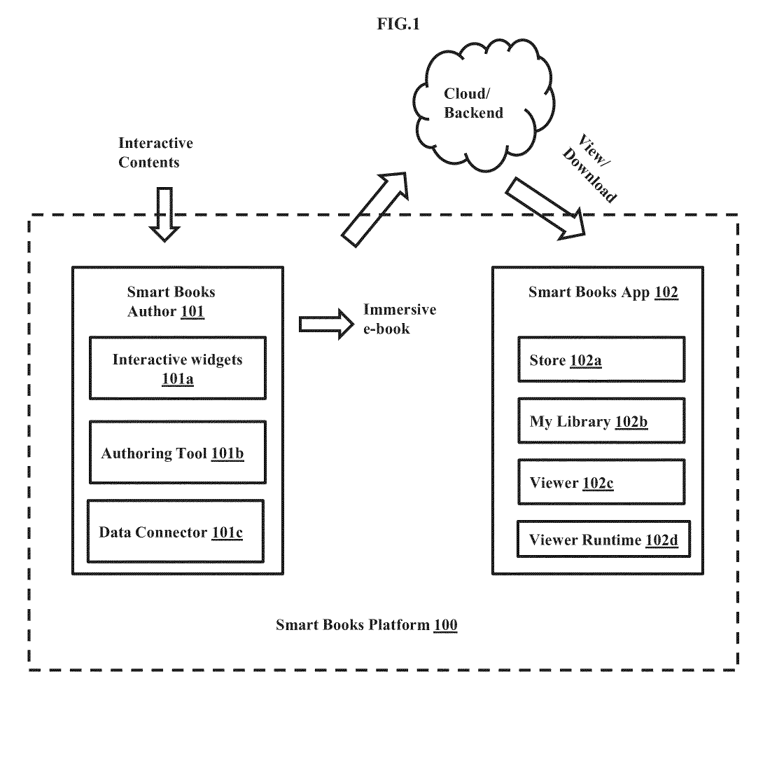

Referring now to the drawings, and more particularly to FIGS. 1 to 5, where similar reference characters denote corresponding features consistently throughout the figures, there are shown embodiments.

FIG. 1 illustrates a block diagram of smart books platform, according to the embodiments disclosed herein. The smart books platform 100 provides a method for adding immersive contents into an existing eBook and also provides an interactive and engaging experience to a user through an application. As depicted in the figure, the smart books platform 100 comprises a smart books author 101 and a smart books application 102. The immersive content for an eBook can be created using smart books author 101. Further, the immersive content of an eBook created using smart books author 101 can be provided to the user through the smart books application 102. The smart books author comprises interactive widgets 101a, an authoring tool 101b (known as smart books authoring tool) and a data connector 101c. The smart books application 102 of smart books platform 100 comprises a store 102a, where the information related to available books are stored, a library 102b, a viewer 102c and a viewer runtime 102d. The smart books author 101 provides an immersive eBook using the interactive widgets 101a and the authoring tool 101b.

In an embodiment, the immersive content created using smart books author 101 is stored in a cloud.

In an embodiment, the immersive content created using smart books author 101 is hosted in a server.

In an embodiment, the immersive eBook can be accessed on a digital device by a user with the help of a smart books application 102. The smart books application 102 needs to be downloaded for viewing the interactive eBook.

In an embodiment, the digital device can be a mobile phone, smart phone, tablet, laptop, personal computer or any other device used exclusively for reading eBooks.

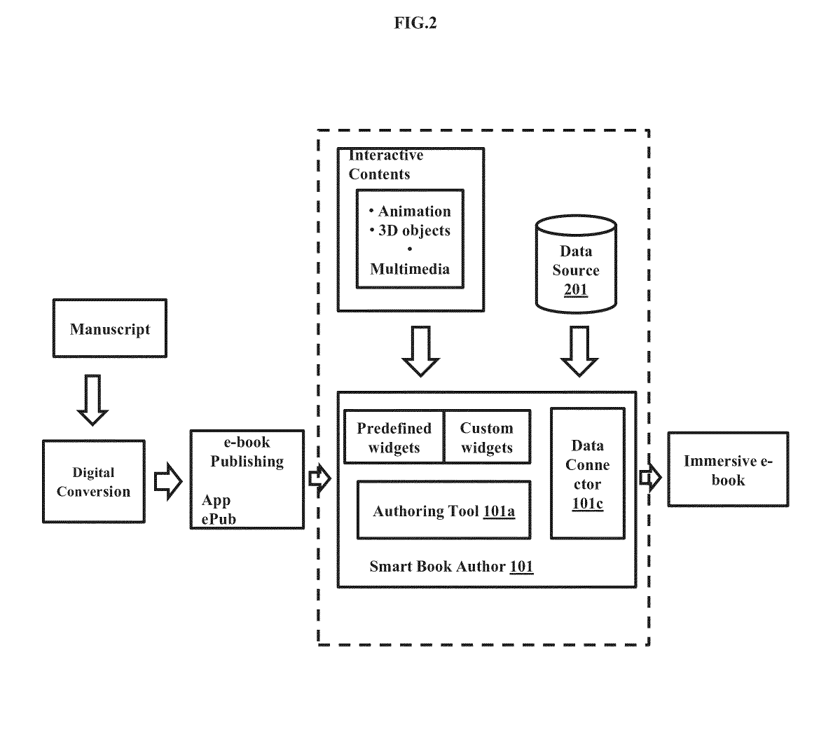

FIG. 2 illustrates a block diagram for smart books with authoring tool, according to the embodiments disclosed herein. The smart books author 101 is used to add immersive contents to existing eBooks. The smart books author 101 provides the interactivity to the existing eBook of a standard format that includes but not limited ePub, HTML, PDF, Doc. Further, the interactivity is provided to the user with the help of interactive widgets. These interactive widgets comprise pre-defined widgets and custom widgets. The immersive or interactive contents are added in the form of widgets. The smart books authoring tool 101b is used to insert the widgets and input the content to the widgets. The smart books author 101 obtains interactive content for creating widgets.

The content for the widgets may include but not limited to animation, 3D objects, multimedia or the like. Further, the smart books authoring tool 101b uses the data connector 101c to input content for each widget.

In an embodiment, the data connector 101c is connected to a data source 201 to input the content for each widget.

In an embodiment, the data source 201 may include external data sources such as CRM, Databases, Social Media, Maps, Analytics or the like.

Widgets represent interactive elements such as (for example, Map, Chart, graph and so on) or an immersive concept (Augmented Reality, Text to Speech etc) or an immersive effect (Rotation, Auto zoom in and zoom out etc). Widgets are actionable elements with which the user can interact in real time. Widgets are inserted as tags in the eBook and the rendering logic for accessing the eBook is provided in the smart books mobile application 102 that is used to interact with the book. The eBook contains only the tags (or identifier) and data definition for each inserted widgets. The viewer application (smart books mobile application 102) renders the electronic document or eBook. The smart books author 101 generates immersive eBook as an output by creating widgets and inputting the content into the widgets.

The generated immersive eBook will be in a tag based format known as Smart Books Markup Language (SBML) and may include additional tags, which are specific to smart books platform.

The static content is stored as a part of the eBook using a static widget, whereas the dynamic content is stored as references to the external data sources.

An interactive experience with dynamic and real time content is provided to the user. This is achieved by creating individual widgets for different types of interactive actions. Further, there exist some pre-defined widgets and custom widgets can also be created. During the authoring process, a relevant widget is selected and mapped to content in the eBook. Any data that is required for the widget is also defined. The data definition can include the actual data or the reference to the data source. The viewer application 102c will access the data source to get the relevant content. Some examples of the custom widgets that provide interactivity apart from videos, pictures and multimedia are explained below:

A world map can be created as a widget; the objective of this widget is to show the geographical location of the place of interest on a world map. Further, a link is provided to the user for finding the place of interest. When the user clicks the link, a map is displayed with the location of place of interest and the current location of the user.

A quiz contest can be created as a widget that provides interaction with the user. The quiz contains a list of questions that is selected at random and displayed to the user. The questions in the quiz may include of multiple choices from which the user selects one correct choice. Feedback is provided for each question with a result which includes correct or incorrect. Further, the correct choice and the explanation is provided to the user for each question in the quiz.

Further, a widget can also be created for an augmented reality application. Augmented reality (AR) is a live, direct or indirect, view of a physical, real-world environment whose elements are augmented by computer-generated sensory input such as sound, video, graphics or GPS data. This could be achieved by using markers. Markers are images that could be tracked (recognized) by the system. When a marker is recognized, the corresponding 3D image is displayed over it.

An audio widget can be created to play an audio associated with the content. Similarly, a video widget can be created for playing a video associated with the context. The video content can be denoted by a play button in the center of an image. The video is played in a full screen mode, when the user clicks on the image.

The functionality of rotation of objects can be created using a widget. With this widget, the objects are rotated by some amount of degree with some speed based on touch. The features like auto zoom in and auto zoom out can also be implemented, when an image is touched. The feature of text to speech can be created as a widget, thereby providing a narration of selected text in the eBook. A widget for sharing comments to facebook and twitter can also be developed.

Further, hyperlinks are created as widgets. These hyperlinks provide links to different portions of the text and data to external eBook. A widget for flipping a selected text can also be created, which provides more information.

A touch map widget can be created, this widget represents a geographical map in which locations are placed as central points. On touching the points, additional data may be shown. A time line widget displays a time line of events. On touching a particular point, a photograph related to a particular time period in history is shown in the background.

A widget that provides a 3D view of an object is created and can be added into the eBook. This widget provides a 3D view of a selected object in the eBook.

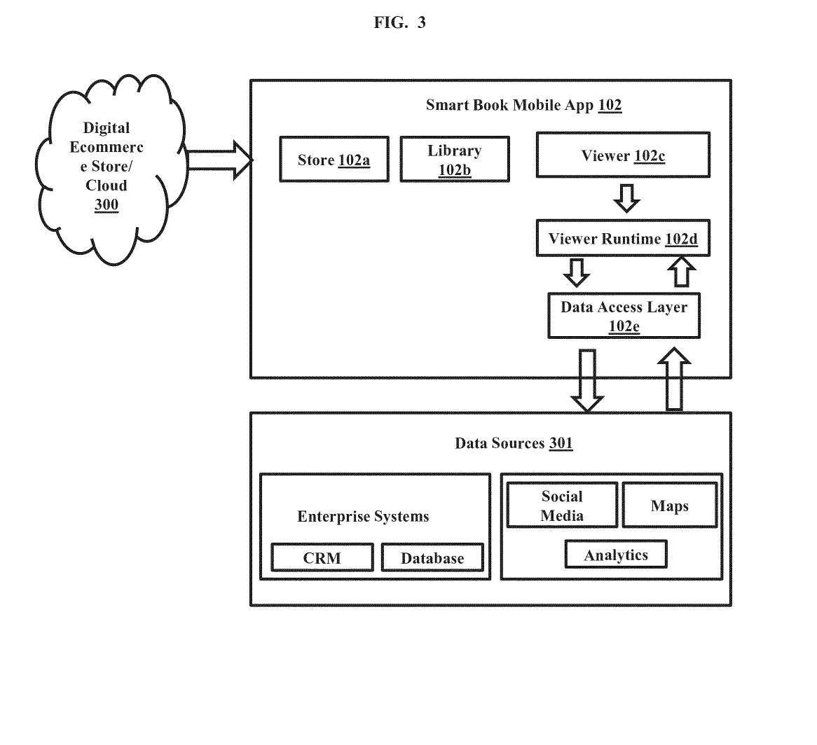

FIG. 3 illustrates architecture of smart books application, according to embodiments disclosed herein. The smart books mobile application 102 of the smart books platform 100 renders the immersive eBook. The smart books mobile application 102 needs to be downloaded by the user for viewing the immersive content with in the eBook. The smart books mobile application 102 comprises a store 102a, a library 102b, a viewer 102c, a viewer runtime 102d, a data access layer 102e. Initially, the smart books mobile application 102 obtains the immersive eBook from a digital E-commerce or a cloud store 300.

The smart books application 102 connects to the store 102a for obtaining the information about the available books and the subscription information. The information about the available books is obtained by application 102 and stored in the library 102b. Further, the immersive contents are displayed by the viewer 102c, according to the effects specified by each widget using viewer runtime 102d. The viewer runtime 102d communicates with the data sources 301 such as such as CRM, Databases, Social Media, Maps, Analytics or the like through a data access layer 102e. The viewer 102c is a user interface, where the immersive contents are displayed to the user. The user can interact with the immersive content using the viewer 102c.

The viewer runtime 102d performs calculations and execution of logic within the widgets. Further, the viewer runtime 102d uses the data access layer 102e to access the content from internal and external data sources such as CRM, Databases and so on. Further, based on the user interaction on the interactive element, the corresponding widget functionality is executed by the viewer runtime 102d.

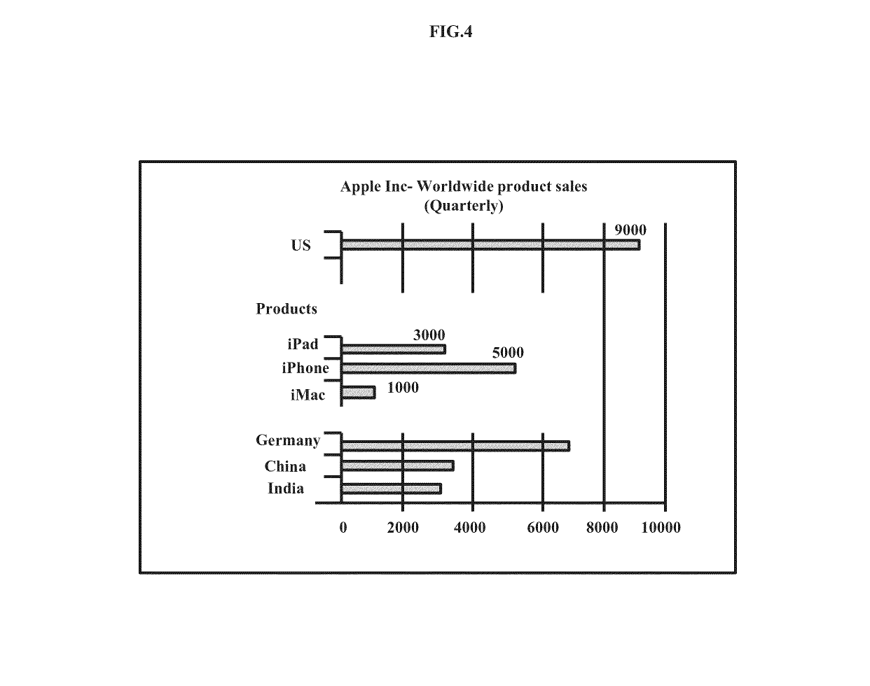

FIG. 4 illustrates an example widget, according to embodiments disclosed herein. The figure depicts a bar chart, which can be drilled down to extract more details by clicking on a bar. In the figure, a graph is plotted to demonstrate the quarterly product sales of Apple Inc., in a quarter. In the diagram shown, more details regarding the product sales in the United States is displayed when the bar is touched.

The smart books platform 100 described herein reduce the time to create an immersive eBook by using the widgets, which can quickly integrate the interactive elements. Further, the smart books platform reduces the time to launch the book as there is no need to create separate application for book or journal.

Further, the method and system disclosed herein provides a real time view of contents by associating data with widgets statically and dynamically. In the static widget, the content is stored in the eBook, whereas the dynamic content is stored as references to external data sources. The method and system of adding immersive content into existing eBooks is applicable in publishing of books, journals, magazines and so on. Further, educational institutions can make their course material by adding immersive content in the form of widgets. Further, the method and system can be implemented in manufacturing industries, where interactive user manuals and interactive service manuals are provided to the customers by adding immersive content in the form of widgets in the eBooks.

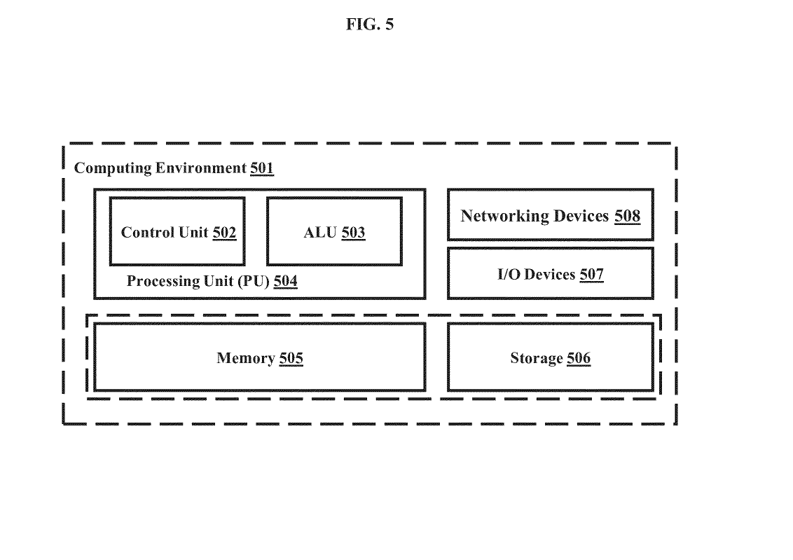

FIG. 5 illustrates a computing environment implementing the smart books platform, as disclosed in the embodiments herein. As depicted the computing environment 501 comprises at least one processing unit 504 that is equipped with a control unit 502 and an Arithmetic Logic Unit (ALU) 503, a memory 505, a storage unit 506, plurality of networking devices 508 and a plurality Input output (I/O) devices 507. The processing unit 504 is responsible for processing the instructions of the algorithm. The processing unit 504 receives commands from the control unit in order to perform its processing. Further, any logical and arithmetic operations involved in the execution of the instructions are computed with the help of the ALU 503.

The overall computing environment 501 can be composed of multiple homogeneous and/or heterogeneous cores, multiple CPUs of different kinds, special media and other accelerators. The processing unit 504 is responsible for processing the instructions of the algorithm. Further, the plurality of processing units 504 may be located on a single chip or over multiple chips.

The algorithm comprising of instructions and codes required for the implementation are stored in either the memory unit 505 or the storage 506 or both. At the time of execution, the instructions may be fetched from the corresponding memory 505 and/or storage 506, and executed by the processing unit 504.

In case of any hardware implementations various networking devices 508 or external I/O devices 507 may be connected to the computing environment to support the implementation through the networking unit and the I/O device unit.

The embodiments disclosed herein can be implemented through at least one software program running on at least one hardware device and performing network management functions to control the elements. The elements shown in FIG. 1 include blocks which can be at least one of a hardware device, or a combination of hardware device and software module.

The embodiments disclosed herein can be implemented through at least one software program running on at least one hardware device and performing network management functions to control the network elements. The network elements shown in FIG. 5 include blocks which can be at least one of a hardware device, or a combination of hardware device and software module.

The embodiment disclosed herein specifies an automated encryption and decryption of user data across tiered self-encrypting Storage devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for providing an interactive eBook to a user, wherein said method comprises:
adding immersive contents into said eBook in the form of interactive widgets by an authoring tool;
converting said eBook with said immersive contents into a format; and
rendering said converted eBook in said format with said immersive contents to said user.

2. The method as in claim 1, wherein said method provides interactivity to said user by using said interactive widgets, wherein said interactive widgets comprises at least one of: pre-defined widgets, custom widgets.

3. The method as in claim 2, wherein said method creates at least one widget for at least one interactive action on said eBook, wherein said eBook with said immersive content is converted into said format by said authoring tool.

4. The method as in claim 2, wherein said method renders said eBook with said immersive contents to said user by an application implemented in a device, wherein said application comprises a viewer runtime for executing said at least one widget.

5. The method as in claim 1, wherein said method associates a data source to said at least one widget while inserting said interactive widgets to said eBook.

6. The method as claim 1, wherein said method further comprises providing dynamic content based on interaction of said user, wherein said dynamic content is extracted from external data sources, wherein said external data sources comprises at least one of: CRM, Databases, Social Media, Maps, graph, Analytics.

7. A system for providing an interactive eBook to a user, wherein said system comprises an authoring tool, an application, wherein said application further comprises a viewer, a viewer runtime along with
an integrated circuit further comprising at least one processor;
at least one memory having a computer program code within said circuit;
said at least one memory and said computer program code with said at least one processor cause said system to:
add immersive contents into said eBook in the form of interactive widgets by said authoring tool;
convert said eBook with said immersive contents into a format; and
render said converted eBook in said format with said immersive contents to said user.

8. A computer program product for providing an interactive eBook to a user, wherein said product comprises an authoring tool, a viewer and a viewer runtime, along with
an integrated circuit further comprising at least one processor;
at least one memory having a computer program code within said circuit;
said at least one memory and said computer program code with said at least one processor cause said product to:
add immersive contents into said eBook in the form of interactive widgets by an authoring tool;
convert said eBook with said immersive contents into a format; and
render said converted eBook in said format with said immersive contents to said user.

9. The computer program product as in claim 8, wherein said product is configured to provide interactivity to said user by using said interactive widgets, wherein said interactive widgets comprises at least one of: pre-defined widgets, custom widgets.

10. The computer program product as in claim 9, wherein said product is configured to create at least one widget for at least one interactive action on said eBook, wherein said ebook with said immersive content is converted into said format by said authoring tool

11. The computer program product as in claim 9, wherein said product is configured to render said eBook with said immersive contents to said user by an application implemented in a device, wherein said application comprises a viewer runtime for executing said at least one widget.

12. The computer program product as in claim 8, wherein said product is configured to associate a data source to said at least one widget while inserting said interactive widgets to said eBook.

13. The computer program product as in claim 8, wherein said product is further configured to provide dynamic content based on interaction of said user, wherein said dynamic content is extracted from external data sources, wherein said external data sources comprises at least one of: CRM, Databases, Social Media, Maps, graph, Analytics.
